(19) United States
(12) Patent Application Publication
(10) Pub. No.: US 2011/0175698 A1
(43) Pub. Date: Jul. 21, 2011

(54) INDUCTOR WITH FERROMAGNETIC METAL FILM

(76) Inventors: Jenq-Gong DUH, Hsinchu City (TW); Yuan-Tai Lai, Hsinchu City (TW)

(21) Appl. No.: 12/690,343

(22) Filed: Jan. 20, 2010

(51) Int. Cl. H01F 27/24

(52) U.S. Cl. 336/212; 336/221

(57) ABSTRACT

The present invention discloses an inductor with a ferromagnetic metal film, which comprises an upper magnetic material layer, a lower magnetic material layer, and a metallic conducting wire. The metallic conducting wire is sandwiched between the upper magnetic material layer and the lower magnetic material layer. Either the upper magnetic material layer or the lower magnetic material layer is a ferromagnetic metal film. The ferromagnetic metal film can effectively converge the magnetic fluxes and enhance the inductance of the inductor. Thus is reduced the thickness of the upper magnetic material layer or lower magnetic material layer and achieved a thin drum inductor.

### FIELD OF THE INVENTION

The present invention relates to an inductor structure, particularly to a thin inductor structure.

### BACKGROUND OF THE INVENTION

Under the tendency toward slim and compact electronic products, a complete circuit system (including active and passive elements) is usually integrated by a high density structure, such as SOC (System On Chip) or SIP (System In Package).

A circuit system chip has passive elements usually including an oscillation circuit, which contains capacitors and inductors. An inductor is normally formed of metallic conducting wires and a magnetic material. A magnetic material can increase inductance and provide an electromagnetic shielding effect. The inductance of an inductor correlates with the permeability and thickness of the magnetic material. A high-permeability ferromagnetic metallic material can reduce the total thickness of an inductor and achieve a thinning effect.

Refer to FIG. 1 for a conventional drum inductor 5. The inductor 5 includes a shielding drum 1 containing ferrite and a metallic conducting wire 2 arranged helically. A resin 3 is filled to protect the metallic conducting wire 2. The metallic conducting wire 2 is electrically connected to two solder pads 4 to form the inductor 5 stacked vertically. Thus, the induction field area of the inductor 5 is increased in a vertical wire-wound way to achieve a greater inductance.

The vertical wire-wound structure of the conventional inductor 5 would not occupy additional area in circuit design. However, a higher inductance needs more winding coils of the metallic conducting wire 2 and a thicker shielding drum 1. Thus, the total thickness of the inductor increases considerably, which not only consumes more material but also impairs the slimming of electronic products.

### SUMMARY OF THE INVENTION

The primary objective of the present invention is to use a ferromagnetic metal film to reduce the thickness of the magnetic material of an inductor.

Another objective of the present invention is to use a ferromagnetic metal film to converge the magnetic fluxes and enhance the induction effect.

To achieve the abovementioned objectives, the present invention proposes an inductor with a ferromagnetic metal film, which comprises an upper magnetic material layer, a lower magnetic material layer, and a metallic conducting wire helically arranged. The metallic conducting wire is sandwiched between the upper and lower magnetic material layers. Either the upper magnetic material layer or the lower magnetic material layer is a ferromagnetic metal film.

The ferromagnetic metal film can effectively converge the magnetic fluxes and enhance the induction effect. Therefore, the inductance of the inductor can be increased and the thickness of the upper or lower magnetic material layer can be reduced. Thus is achieved a thin inductor structure.

### BRIEF DESCRIPTION OF THE DRAWINGS

FIG. 1 is a diagram schematically showing a conventional inductor;

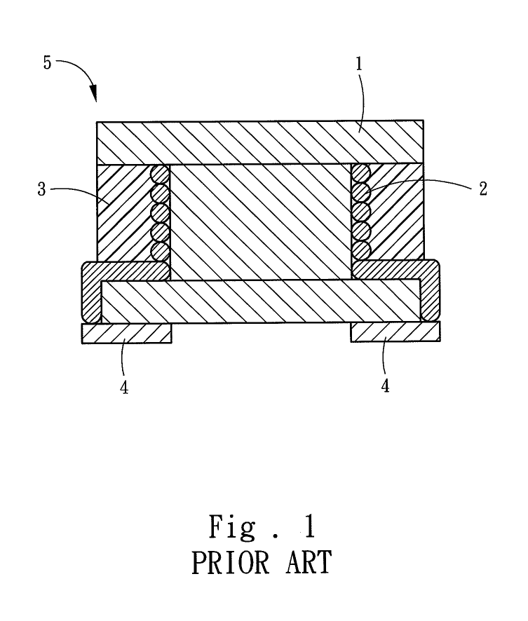

FIG. 2 is a diagram schematically showing a first embodiment of the present invention;

FIG. 3 is a diagram schematically showing a second embodiment of the present invention;

FIG. 4 is a diagram schematically showing a third embodiment of the present invention;

FIG. 5 is a diagram schematically showing a fourth embodiment of the present invention; and

FIG. 6 is a diagram schematically showing a fifth embodiment of the present invention.

### DETAILED DESCRIPTION OF THE PREFERRED EMBODIMENTS

Below, the embodiments are described in detail to demonstrate the technical contents of the present invention. However, it should be understood that the embodiments are only to exemplify the present invention but not to limit the scope of the present invention.

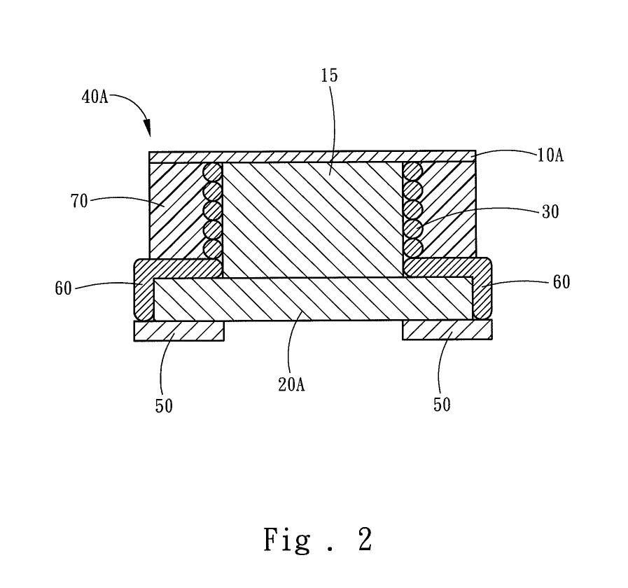

Refer to FIG. 2 for a first embodiment of the present invention. In the first embodiment, an inductor 40A comprises an upper magnetic material layer 10A, a lower magnetic material layer 20A, and a metallic conducting wire 30 arranged helically. The metallic conducting wire 30 is sandwiched between the upper magnetic material layer 10A and the lower magnetic material layer 20A. In the first embodiment, the lower magnetic material layer 20A may be made of a ferrite-based material. The upper magnetic material layer 10A has a smaller thickness and is a ferromagnetic metal film made of iron, cobalt, nickel or an alloy thereof.

In the first embodiment, the inductor 40A further comprises two solder pads 50 and two conducting wires 60. The two solder pads 50 are located below the lower magnetic material layer 20A and respectively connected to two ends of the metallic conducting wire via the two conducting wires 60.

In the first embodiment, a resin 70 is filled into between the upper magnetic material layer 10A and the lower magnetic material layer 20A to cover and protect the metallic conducting wire 30. The upper magnetic material layer 10A and the lower magnetic material layer 20A are connected by a columnar magnetic material layer 15. The metallic conducting wire 30 is helically wound on the columnar magnetic material layer 15. The columnar magnetic material layer 15 may be made of a ferrite-based material or other magnetic materials.

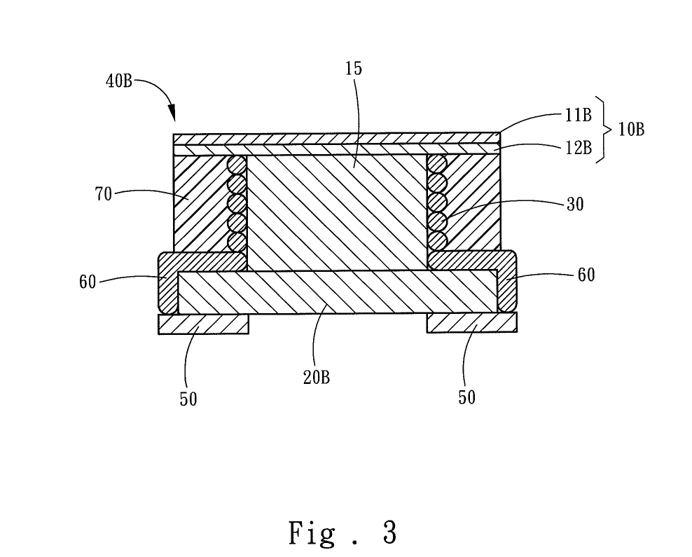

Refer to FIG. 3 for a second embodiment of the present invention. The second embodiment is basically similar to the first embodiment. In the second embodiment, an inductor 40B comprises an upper magnetic material layer 10B, a lower magnetic material layer 20B, and a metallic conducting wire 30 arranged helically. The second embodiment is different from the first embodiment in that the upper magnetic material layer 10B further comprises a first upper magnetic material layer 11B and a second upper magnetic material layer 12B. The first upper magnetic material layer 11B is a ferromagnetic metal film, and the second upper magnetic material layer 12B is made of a ferrite-based material. In the second embodiment, although the thickness of the upper magnetic material layer 10B is slightly increased, the second upper magnetic material layer 12B thereof can increase the inductance.

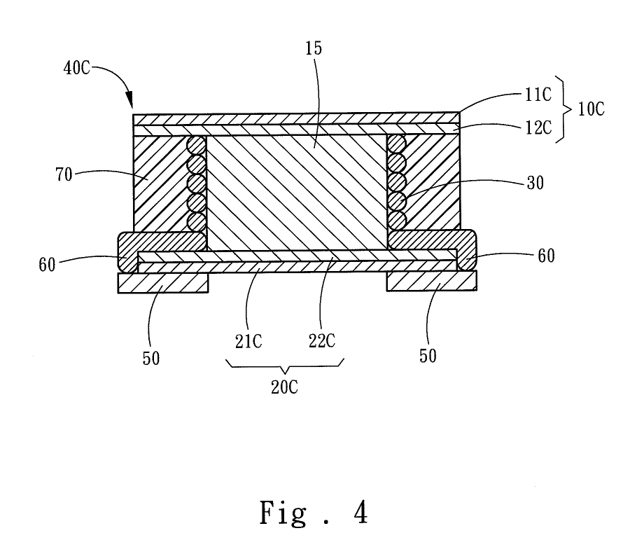

Refer to FIG. 4 for a third embodiment of the present invention. In the third embodiment, an inductor 40C comprises an upper magnetic material layer 10C, a lower magnetic material layer 20C, and a metallic conducting wire 30 arranged helically. Similarly to the second embodiment, the upper magnetic material layer 10C also includes a first upper magnetic material layer 11C and a second upper magnetic material layer 12C. Further, the lower magnetic material layer 20C includes a first lower magnetic material layer 21C and a second lower magnetic material layer 22C. The first upper magnetic material layer 11C and the first lower magnetic material layer 21C are ferromagnetic metal films. The second upper magnetic material layer 12C and the second lower magnetic material layer 22C are made of a ferrite-based material. Because of the ferromagnetic metal film of the first lower magnetic material layer 21C, the total thickness of the lower magnetic material layer 20C is decreased in comparison with that of the first or second embodiment.

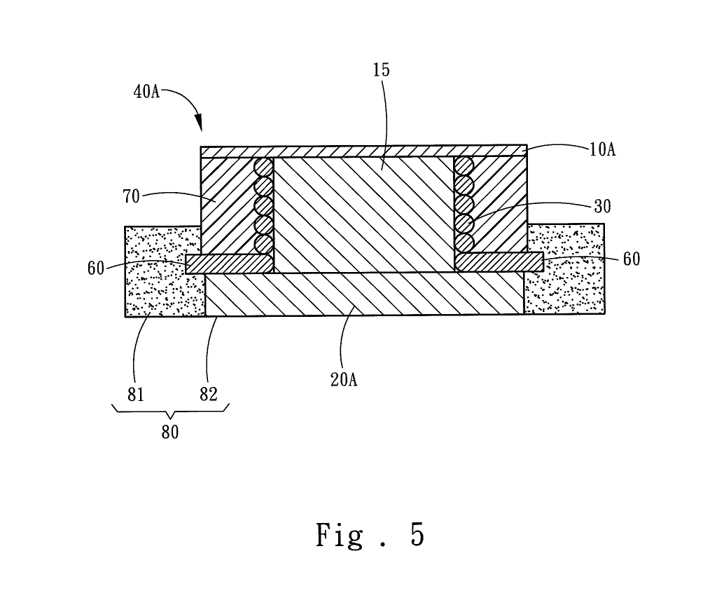

Refer to FIG. 5 for a fourth embodiment of the present invention. The inductor 40A of the fourth embodiment has a structure similar to that of the first embodiment. In the fourth embodiment, the inductor 40A is integrated with a baseplate 80. The baseplate 80 includes a substrate 81 and a via-hole 82 formed on the substrate 81 and receiving the inductor 40A. The via-hole 82 is fabricated with an etching or drilling method on the substrate 81. The substrate 81 is made of silicon, aluminum oxide, or gallium arsenide, or is a printed circuit board.

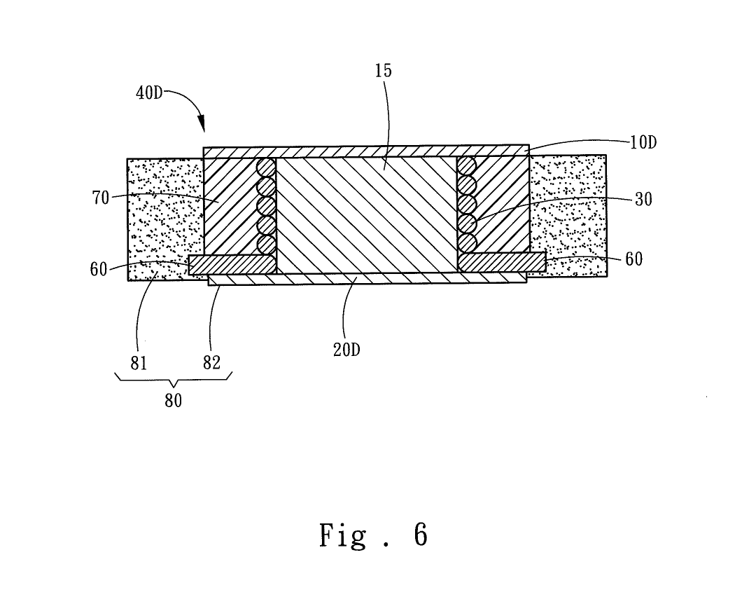

Refer to FIG. 6 for a fifth embodiment of the present invention. In the fifth embodiment, an inductor 40D comprises an upper magnetic material layer 10D, a lower magnetic material layer 20D, and a metallic conducting wire 30 arranged helically. The inductor 40D of the fifth embodiment has a structure similar to that of the fourth embodiment. However, the lower magnetic material layer 20D is a ferromagnetic metal film and has a thickness smaller than that of the lower magnetic material layer 20A of the fourth embodiment. Thus, the inductor 40D is almost coplanar with the baseplate 80. Thereby is further thinned the inductor structure.

In the present invention, the ferromagnetic metal film can effectively converge the magnetic fluxes and enhance the inductance of the inductor. Thus is reduced the thickness of the upper or lower magnetic material layer and achieved a thin inductor structure. Furthermore, the inductor of the present invention can integrate with the baseplate 80 to increase the package density and decrease the volume of electronic products.

What is claimed is:

1. An inductor with a ferromagnetic metal film, comprising:
an upper magnetic material layer;
a lower magnetic material layer, and
a metallic conducting wire sandwiched between the upper magnetic material layer and the lower magnetic material layer,
wherein either the upper magnetic material layer or the lower magnetic material layer is a ferromagnetic metal film.

2. The inductor with a ferromagnetic metal film according to claim 1 further comprising two solder pads and two conducting wires, wherein the two solder pads are located below the lower magnetic material layer and respectively connected to two ends of the metallic conducting wire via the two conducting wires.

3. The inductor with a ferromagnetic metal film according to claim 1, wherein a resin is filled into between the upper magnetic material layer and the lower magnetic material layer to cover the metallic conducting wire.

4. The inductor with a ferromagnetic metal film according to claim 1, wherein the upper magnetic material layer and the lower magnetic material layer are connected by a columnar magnetic material layer; the metallic conducting wire is helically wound on the columnar magnetic material layer.

5. The inductor with a ferromagnetic metal film according to claim 4, wherein the lower magnetic material layer and the columnar magnetic material layer are made of a ferrite-based material; the upper magnetic material layer is a ferromagnetic metal film made of iron, cobalt, nickel or an alloy including at least two of iron, cobalt and nickel.

6. The inductor with a ferromagnetic metal film according to claim 1, wherein the upper magnetic material layer further comprises a first upper magnetic material layer and a second upper magnetic material layer; the first upper magnetic material layer is a ferromagnetic metal film, and the second upper magnetic material layer is made of a ferrite-based material.

7. The inductor with a ferromagnetic metal film according to claim 6, wherein the lower magnetic material layer further comprises a first lower magnetic material layer and a second lower magnetic material layer; the first lower magnetic material layer is a ferromagnetic metal film, and the second lower magnetic material layer is made of a ferrite-based material.

8. The inductor with a ferromagnetic metal film according to claim 1, wherein the ferromagnetic metal film is made of iron, cobalt, nickel or an alloy including at least two of iron, cobalt and nickel.

9. The inductor with a ferromagnetic metal film according to claim 1, wherein the inductor is installed on a baseplate; the baseplate further comprises a substrate and a via-hole formed on the substrate and receiving the inductor.

10. The inductor with a ferromagnetic metal film according to claim 9, wherein the via-hole is fabricated with etching the substrate.

11. The inductor with a ferromagnetic metal film according to claim 9, wherein the via-hole is fabricated with drilling the substrate.

12. The inductor with a ferromagnetic metal film according to claim 9, wherein the substrate is made of silicon, aluminum oxide, gallium arsenide, or is a printed circuit board.

13. The inductor with a ferromagnetic metal film according to claim 9, wherein both the upper magnetic material layer and the lower magnetic material layer are ferromagnetic metal films.
